(19) United States
(12) Patent Application Publication
(10) Pub. No.: US 2015/0012924 A1
(43) Pub. Date: Jan. 8, 2015

(54) Method and Device for Loading a Plug-In

(71) Applicant: Tencent Technology (Shenzhen) Company Limited, Guangdong (CN)

(72) Inventors: Renfang Liu, Guangdong (CN); Bo Hu, Guangdong (CN); Zhipei Wang, Guangdong (CN); Ruiyi Zhou, Guangdong (CN); Xi Wang, Guangdong (CN); Zhengkai Xie, Guangdong (CN); Ying Huang, Guangdong (CN); Wei Li, Guangdong (CN); Cheng Feng, Guangdong (CN); Kai Zhang, Guangdong (CN); Huijiao Yang, Guangdong (CN)

(73) Assignee: Tencent Technology (Shenzhen) Company Limited, Guangdong (CN)

(21) Appl. No.: 14/468,548

(22) Filed: Aug. 26, 2014

Related U.S. Application Data
(63) Continuation of application No. PCT/CN2013/089799, filed on Dec. 18, 2013.

(30) Foreign Application Priority Data
Mar. 14, 2013 (CN) 201310081735.7

(51) Int. Cl. G06F 9/445; G06F 9/54

(52) U.S. Cl. CPC G06F 9/44526; G06F 9/542
USPC 719/318

(57) ABSTRACT

A method for loading a plug-in is disclosed. The method includes: capturing , at a terminal, a plug-in calling event; obtaining, at a terminal, a plug-in identification corresponding to the plug-in calling event; searching, at a terminal, for runtime files corresponding to the plug-in identification locally; obtaining, at a terminal, a preset plug-in download address when the runtime files are not found, and downloading, at a terminal, the runtime files corresponding to the plug-in identification according to the plug-in download address; loading, at a terminal, the runtime files, and calling, at a terminal, corresponding event handlers to handle the plug-in calling event. In addition, a device for loading plug-in is also disclosed. The method and device for loading a plug-in can improve browsing speed.

### CROSS REFERENCE TO RELATED APPLICATION

This application is a continuation application of the PCT International Application No. PCT/CN2013/089799, filed on Dec. 18, 2013, entitled “METHOD AND DEVICE FOR LOADING A PLUG-IN” by Renfang LIU, Bo HU, Zhipei WANG, Ruiyi ZHOU, Xi WANG, Zhengkai XIE, Ying HUANG, Wei LI, Cheng FENG, Kai ZHANG and Huijiao YANG, which claims the priority from the Chinese patent application No. CN 201310081735.7, filed on Mar. 14, 2013. The above-referenced applications are hereby incorporated herein in their entireties by reference.

### FIELD OF THE INVENTION

The present disclosure relates to mobile internet technology filed, more particularly to a method and a device for loading a plug-in.

### BACKGROUND OF THE INVENTION

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admission of prior art.

With the development of the mobile internet technology, smart terminal has been widely used, such as smart phones and tablet computers. Smart phones can access the internet via data channels. A user may browse a webpage with a browser implemented in a smartphone.

The browser of conventional smart phone has a plug-in interface. When the native event handlers cannot handle the browser event triggered by the user, event handlers within corresponding plug-in will be called to handle this event. For example, if a loaded webpage resource file contains pdf documents, while browser native event handlers cannot process pdf documents the browser can process the pdf documents through calling corresponding event handlers within the pdf preview plug-in, thereby implementing the function of previewing pdf documents which the browser does not itself have.

However, conventional browser needs to download an installation package to install before loading a plug-in. For example, in an Android system, one must pre-download apk installation file of the plug-in, and install the plug-in to the Android system using its installation tools , and then restart the browser, so that the installed event handlers can be called when a corresponding event is captured. For this reason, a user has to wait for a long time for installing and restarting when extending browsers functions, which affects the browsing speed.

### SUMMARY OF THE INVENTION

In view of the above, it is necessary to provide a method for loading a plug-in with improved browsing speed.

According to one aspect of the disclosure, the method for loading a plug-in includes:
capturing, at a terminal, a plug-in calling event;
obtaining, at a terminal, a plug-in identification corresponding to the plug-in calling event;
searching, at a terminal, for runtime files corresponding to the plug-in identification locally;
obtaining, at a terminal, a preset plug-in download address when the runtime files are not found, and downloading, at a terminal, runtime files corresponding to the plug-in identification according to the plug-in download address;
loading, at a terminal, the runtime files, and calling, at a terminal, corresponding event handlers to handle the plug-in calling event.

In addition, it is necessary to provide a terminal including a plug-in loading device which may improve browsing speed.

According to another aspect of the disclosure, the device for loading a plug-in includes:
an event capturing module configured to capture a plug-in calling event;
a plug-in identification obtaining module configured to obtain a plug-in identification corresponding to the plug-in calling event;
a local searching module configured to find runtime files corresponding to the plug-in identification in local;
a plug-in downloading module configured to obtain a preset plug-in download address when the runtime files are not found, and download runtime files corresponding to the plug-in identification according to the plug-in download address;
a plug-in loading module configured to load the runtime files, and call corresponding event handlers to handle the plug-in calling event.

According to a further aspect of the disclosure, a non-transitory computer-readable storage medium including an executable program to execute a method for loading a plug-in is disclosed, wherein the method including:
capturing, at a terminal, a plug-in calling event;
obtaining, at a terminal, a plug-in identification corresponding to the plug-in calling event;
searching, at a terminal, for runtime files corresponding to the plug-in identification locally;
obtaining, at a terminal, a preset plug-in download address when the runtime files are not found, and downloading, at a terminal, runtime files corresponding to the plug-in identification according to the plug-in download address;
loading, at a terminal, the runtime files, and calling, at a terminal, corresponding event handlers to handle the plug-in calling event.

The method and device for loading a plug-in can automatically download the runtime files corresponding to the plug-in when the browser is not installed with a plug-in, and then call corresponding event handlers to handle corresponding plug-in calling event by loading the runtime files, allowing the user to call the plug-in, without installing the plug-in through the operating system. There is no need to restart the browser to reload the installed plug-in during the calling procedure, which facilitates the browser plug-in calling and thus improves browsing speed.

### BRIEF DESCRIPTION OF DRAWINGS

FIG. 1 is a flowchart illustrating a method for loading a plug-in according to one embodiment of the present disclosure;

FIG. 2 is an interface diagram illustrating a browser during the process of calling a plug-in according to one embodiment of the present disclosure;

FIG. 3 is an interface diagram illustrating a browser during the process of calling a plug-in according to one embodiment of the present disclosure;

FIG. 4 is an interface diagram illustrating a browser during the process of calling a plug-in according to one embodiment of the present disclosure;

FIG. 5 is a schematic diagram illustrating a structure of a device for loading a plug-in according to one embodiment of the present disclosure;

FIG. 6 is a schematic diagram illustrating a structure of a device for loading a plug-in according to another embodiment of the present disclosure.

FIG. 7 depicts an exemplary computing system consistent with the disclosed embodiments.

### DETAILED DESCRIPTION OF THE INVENTION

The accompanying drawings illustrate one or more embodiments of the disclosure and together with the written description, serve to explain the principles of the disclosure. Wherever possible, the same reference numbers are used throughout the drawings to refer to the same or like elements of an embodiment.

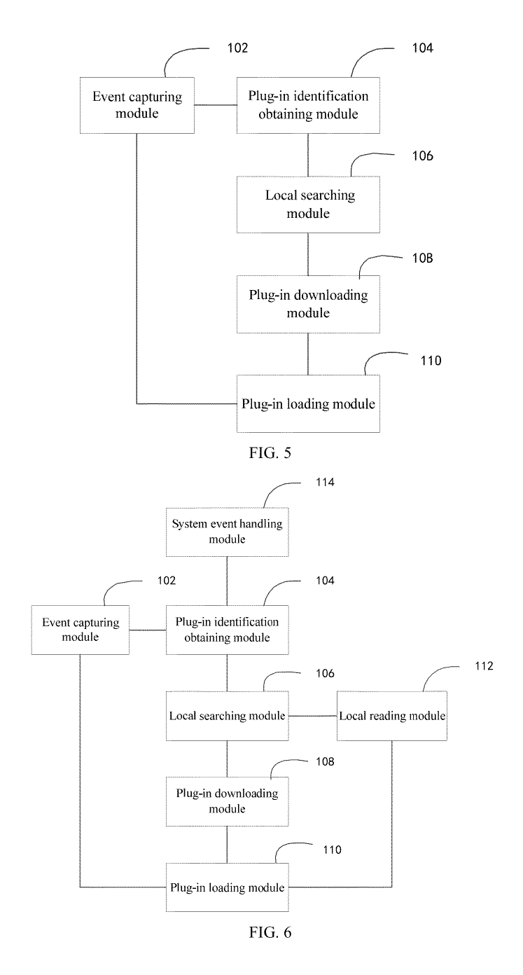

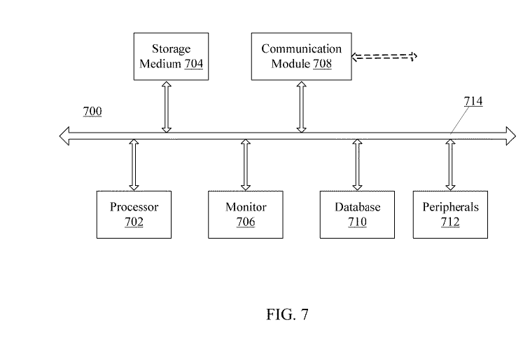

FIG. 7 shows a block diagram of an exemplary computing system 700 (or computer system 700) capable of implementing a terminal which includes the device as illustrated in FIGS. 5 and 6 and as described below. A terminal, as used herein, may refer to any appropriate user terminal with certain computing capabilities, e.g., a personal computer (PC), a work station computer, a hand-held computing device (e.g., a tablet), a mobile terminal (e.g., a mobile phone or a smart phone), or any other client-side computing device. As shown in FIG. 7, the exemplary computer system 700 may include a processor 702, a storage medium 704, a monitor 706, a communication module 708, a database 710, peripherals 712, and one or more bus 714 to couple the devices together. Certain devices may be omitted and other devices may be included.

The processor 702 can include any appropriate processor or processors. Further, the processor 702 can include multiple cores for multi-thread or parallel processing. The storage medium 704 may include memory modules, e.g., Read-Only Memory (ROM), Random Access Memory (RAM), and flash memory modules, and mass storages, e.g., CD-ROM, U-disk, removable hard disk, etc. The storage medium 704 may store computer programs for implementing various processes, when executed by the processor 702.

The monitor 706 may include display devices for displaying contents in the computing system 700. The peripherals 712 may include I/O devices such as keyboard and mouse.

Further, the communication module 708 may include network devices for establishing connections through the communication network. The database 710 may include one or more databases for storing certain data and for performing certain operations on the stored data. The methods and systems disclosed in accordance with various embodiments can be executed by a computer system. In one embodiment, the disclosed methods and systems can also be implemented by a server.

Various embodiments provide methods and systems for loading a plug-in. The methods and systems are illustrated in various examples described herein.

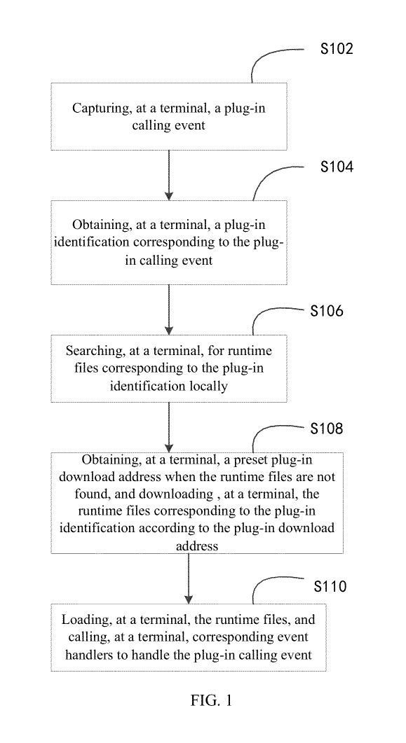

In one embodiment, as illustrated in FIG. 1, a method for loading a plug-in, which is achieved entirely by a computer program, includes following steps:

Step S102, capturing, at a terminal, a plug-in calling event.

The plug-in calling event is a browser event for calling a corresponding plug-in, which is trigged by an operation behavior input via a browser by the user.

For example, if the webpage being browsed via the browser includes a resource file of pdf document, the browser will throw a plug-in calling event for previewing pdf document when it loads the webpage, for calling a corresponding plug-in for previewing pdf document to see the pdf document. If a webpage is determined to be one of the members on the preset shopping website list, the browser will obtain product and price information from the webpage, and throw the plug-in calling event based on the product and price information in order to call the corresponding price comparing plug-in to do the prices search on multiple shopping sites and compare the prices of a certain product.

In one embodiment, all plug-ins supported by the browser (only supports, does not necessarily have to install the plug-in) may be pre-displayed in forms of icons or links, and the plug-in calling event is captured by obtaining the icons or clicking on the links.

Step S104, obtaining, at a terminal, a plug-in identification corresponding to the plug-in calling event.

In one embodiment, the plug-in calling event has an event identification. A corresponding relationship between the plug-in calling event and the plug-in identification is pre-built. The plug-in identification corresponding to the plug-in calling event may be found based on the corresponding relationship.

Step S106, searching, at a terminal, for runtime files corresponding to the plug-in identification locally.

The runtime files are program files of the plug-ins corresponding to the plug-in identifications. The runtime files include library function files and/or resource files. The library function files can be binary files. For example, in an Android system, the library function files can be dex files. In a java virtual machine-based system, the library function files can be class files. The resource files may include pictures, audio and video files, etc.

In one embodiment, a local plug-in list may be obtained. The local plug-in list records the plug-in identification of the plug-in contained in the browser and the local storage location of the runtime files corresponding to the plug-in. The step of searching, at a terminal, for the runtime files corresponding to the plug-in identification in local particularly includes: determining whether the obtained plug-in identification belongs to the local plug-in list, if yes, found; otherwise, not found.

Step S108, obtaining, at a terminal, a preset plug-in download address when the runtime files are not found, and downloading, at a terminal, the runtime files corresponding to the plug-in identification according to the plug-in download address.

A server may be preset for publishing the plug-in. The server may pre-package the runtime files corresponding to the published plug-in into a compression package. The plug-in download address is an address of the server. The plug-in download address may be pre-stored in configuration files of the browser, and correspond to the plug-in identification. Readable configuration files obtain the plug-in download address corresponding to the plug-in identification, download the compression package according to the read plug-in download address, and obtain the runtime files by extracting the compression package.

In one embodiment, after the step of downloading, at a terminal, the runtime files corresponding to the plug-in identification according to the plug-in download address, the runtime files may be verified.

For example, the server stores the runtime files of the published plug-in and a corresponding md5 code thereof. After downloading the runtime files according to the plug-in download address, the md5 of the runtime files is continued to download, then the downloaded runtime files are verified according to md5 code. By doing so, it prevent virus or Trojan from being implanted when downloading the plug-in, which improves security.

In one embodiment, after the step of searching, at a terminal, for the runtime files corresponding to the plug-in identification locally, the runtime files are read.

In this embodiment, if the local plug-in list includes the plug-in identification, the runtime files are found. A local storage location of the runtime files corresponding to the plug-in identification is obtained from the local plug-in list, and the runtime files are read according to the storage location.

In this embodiment, after the runtime files corresponding to the plug-in identification have been downloaded, it can be stored in the local storage unit. After the storage location is associated with the plug-in identification, it is added to the local plug-in list. When the user calls the plug-in again, the plug-in can be directly read without downloading.

Step S110, loading, at a terminal, the runtime files, and calling, at a terminal, corresponding event handlers to handle the plug-in calling event.

Loading the runtime files means loading the runtime files to internal memory via calling a class loader function of an operating system. For example, a class file is loaded into the internal memory via a class loader in a java-based operating system.

In one embodiment, the step of calling, at a terminal, corresponding event handlers to handle the plug-in calling event particularly includes: creating a plug-in object instance corresponding to the runtime files through a reflection mechanism, and calling the event handlers of the plug-in object instance to handle the plug-in calling event.

The reflection mechanism is a runtime code assembly mechanism, which maps to get classes, properties and function definitions according to binary internal memory of library function during runtime, and dynamically creates an object instance according to the properties and function definitions.

In this embodiment, a function name of the event handlers corresponding to the event identification of the plug-in calling event may be preset. The corresponding event handlers may be obtained from the plug-in object instance by the function name, and then handle the plug-in calling event.

For example, as mentioned above, if the captured plug-in calling event is a event for comparing prices, then the runtime files corresponding to the plug-in for comparing prices is firstly loaded into the internal memory. Next, a corresponding plug-in object instance is created by the reflection mechanism, then the event handlers in the plug-in object instance is called according to the preset function name. The product information and product price contained in the event for comparing prices are passed as parameters to the event handlers, which can search price information of multiple products that are the same or similar, from multiple shopping sites according to a predefined event handling logic therein, and generate corresponding price comparison curves to be presented to the user.

In one embodiment, before the step of searching, at a terminal, for the runtime files corresponding to the plug-in identification locally, the support plug-in list may be obtained, and whether the plug-in identification belongs to the supported plug-in list is determined, if yes, the step of searching, at a terminal, for the runtime files corresponding to the plug-in identification is continued to perform.

In this embodiment, after the step of determining, at a terminal, whether the plug-in identification belongs to the support plug-in list, the plug-in calling event is handled by calling event handlers of the operating system when the plug-in identification does not belong to the support plug-in list.

The support plug-in list may be downloaded by the server, and the support plug-in list may record the plug-in identification of the published plug-in stored in the server.

When the plug-in identification does not belong to the support plug-in list, it means that the browser and the plug-in supported by the browser cannot handle the plug-in calling event, and the plug-in calling event will be thrown as an operating system event, which is then handled via calling the event handlers of the operating system.

As mentioned in the previous embodiment, in one application scene, if a webpage which the user browsed includes resource files containing a pdf document, while there is no corresponding plug-in for viewing pdf document in the supported plug-in list, a plug-in calling event for previewing pdf document will be thrown up, and preview the pdf document by calling an interface function of pdf viewing program in the operating system. For example, the pdf document may be previewed by calling the interface function of pdf application such as adobe reader or foxit reader, etc., and the pdf document name is passed as a parameter to the interface function in order to preview the pdf document.

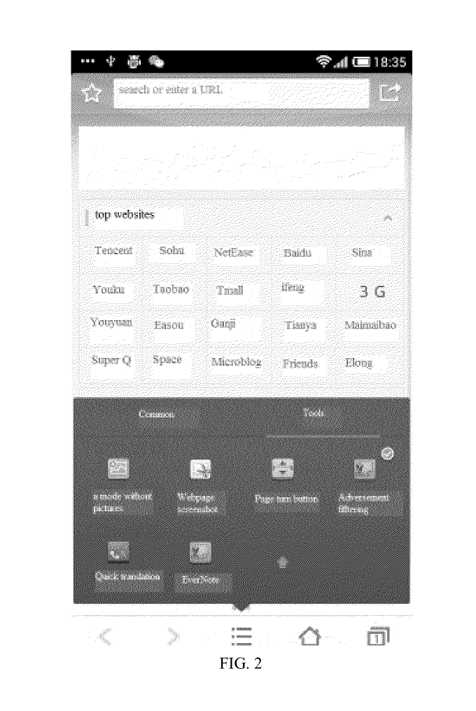

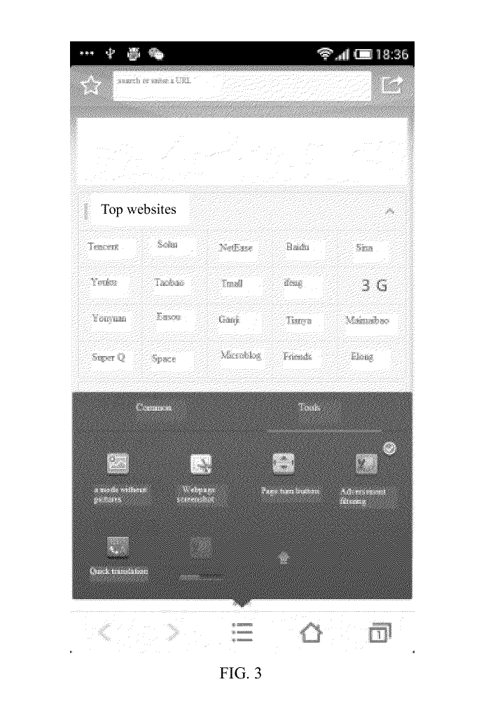

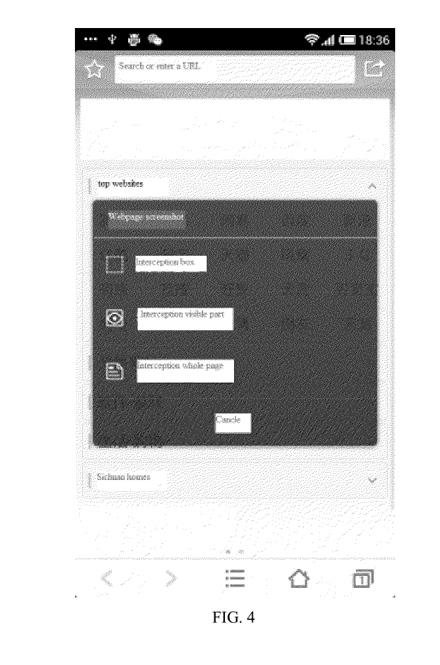

In another application scene, referring to FIGS. 2, 3 and 4, the user can click on a toolbar of a mobile phone browser to expand the supported plug-in list. The toolbar displays a plurality of the plug-ins in the form of ions in the supported plug-in list. If the user wants to call “EverNote” plug-in to record essays diary, he /she would click on the icon corresponding to the “EverNote” plug-in to trigger a plug-in calling event. Once the local searching find that the “EverNote” plug-in has not been downloaded, the “EverNote” plug-in will be downloaded by accessing the browser according to the preset plug-in download address. At the same time, the download progress of the runtime files corresponding to the plug-in appears as a progress bar below the icon. After the download, the runtime files will be stored in a preset local storage address, recorded in the local plug-in list. At the same time, the downloaded runtime files are loaded, and the plug-in object instance is created by the reflection mechanism. The corresponding event handlers in the plug-in object instance are then called to handle the plug-in calling event, that is, opening an input window for entering notes that facilitates the user's input. The whole process does not involve installation of application by the operating system, or restarting the browser after download, thereby it is a convenience for the user when calling the plug-in, which improves browsing speed.

In one embodiment, as illustrated in FIG. 5, a device for loading a plug-in includes an event capturing module 102, a plug-in identification obtaining module 104, a local searching module 106, a plug-in downloading module 108 and a plug-in loading module 110, wherein,

The event capturing module 102 is configured to capture a plug-in calling event.

The plug-in calling event is a browser event for calling a corresponding plug-in, which is trigged by user's operation behavior input via a browser.

For example, if a webpage which the user browsed via the browser includes the type of resource files of pdf document, the browser will throw a plug-in calling event of preview pdf document when it loads the webpage, for calling a corresponding plug-in for previewing pdf document to see the pdf document. If the webpage is a shopping website, thus after determining the accessed webpage belongs to a preset shopping website list, the browser will obtain product information and price information in the webpage, and throw the plug-in calling event based on the product information and price information, for calling a corresponding plug-in for comparing prices to search corresponding prices of the same product on multiple shopping sites.

In one embodiment, all plug-ins supported by the browser (only supports, does not necessarily have to install the plug-in) may be pre-displayed in forms of icons or links, and the plug-in calling event is captured by obtaining the icons or clicking on the links.

The plug-in identification obtaining module 104 is configured to obtain a plug-in identification corresponding to the plug-in calling event.

In one embodiment, the plug-in calling event has an event identification. A corresponding relationship between the plug-in calling event and the plug-in identification is prebuilt. The plug-in identification obtaining module 104 can be configured to find the plug-in identification corresponding to the plug-in calling event based on the corresponding relationship.

The local searching module 106 is configured to find runtime files corresponding to the plug-in identification in local.

The runtime files are program files of the plug-ins corresponding to the plug-in identification. The runtime files include library function files and/or resource files. The library function files can be binary files. For example, in an Android system, the library function files can be dex files. In a java virtual machine-based system, the library function files can be class files. The resource files may include pictures, audio and video files, etc.

In one embodiment, the local searching module 106 may be configured to obtain a local plug-in list. The local plug-in list records the plug-in identification of the plug-in which has been contained in the browser and a storage location in local of the runtime files corresponding to the plug-in. The local searching module 106 also may be configured to determine whether the obtained plug-in identification belongs to the local plug-in list, if yes, find; otherwise, not find.

The plug-in downloading module 108 is configured to obtain a preset plug-in download address when not finding the runtime files, and download the runtime files corresponding to the plug-in identification according to the plug-in download address.

A server may be preset for publishing the plug-in. The server may pre-package the runtime files corresponding to the published plug-in into a compression package. The plug-in download address is an address of the server. The plug-in download address may be pre-stored in configuration files of the browser, and correspond to the plug-in identification. Readable configuration files obtain the plug-in download address corresponding to the plug-in identification, download the compression package according to the read plug-in download address, and obtain the runtime files by extracting the compression package.

In one embodiment, the plug-in downloading module 108 also may be configured to verify the runtime files after downloading the runtime files corresponding to the plug-in identification according to the plug-in download address.

For example, the server stores the runtime files of the published plug-in and a corresponding md5 code thereof. After downloading the runtime files according to the plug-in download address, the md5 of the runtime files is continued to download, then the downloaded runtime files are verified according to md5 code, thus preventing the plug-in from being implanted virus or Trojan during download, improving safety.

In one embodiment, as illustrated in FIG. 6, the device for loading a plug-in further includes a local reading module 112 configured to read the runtime files when having found the runtime files in local.

In this embodiment, if the local plug-in list includes the plug-in identification, the runtime files are found. The local reading module 112 may be configured to obtain a storage location in local of the runtime files corresponding to the plug-in identification in the local plug-in list, and read the runtime files according to the storage location.

In this embodiment, after the runtime files corresponding to the plug-in identification have been downloaded, it can be stored in the local storage unit, and after the storage location is associated with the plug-in identification, the storage location is added to the local plug-in list. When the user calls the plug-in again, the plug-in can be directly read without downloading.

The plug-in loading module 110 is configured to load the runtime files, and call corresponding event handlers to handle the plug-in calling event.

Loading the runtime files is that loading the runtime files to internal memory via calling a class loader function of an operating system. For example, a class file is loaded into the internal memory via a class loader in a java-based operating system.

In one embodiment, the plug-in loading module 110 may be configured to create a plug-in object instance corresponding to the runtime files through a reflection mechanism, and call the event handlers of the plug-in object instance to handle the plug-in calling event.

The reflection mechanism is a runtime code assembly mechanism, which maps to get classes, properties and function definitions according to binary internal memory of library function during runtime, and dynamically create an object instance according to the properties and function definitions.

In this embodiment, a function name of the event handlers corresponding to the event identification of the plug-in calling event may be preset, and the corresponding event handlers may be obtained in the plug-in object instance through the function name, then the event handlers handle the plug-in calling event.

For example, as mentioned above, if the captured plug-in calling event is a event for comparing prices, then the runtime files corresponding to the plug-in for comparing prices is firstly loaded into the internal memory, then a corresponding plug-in object instance is created by the reflection mechanism, then the event handlers in the plug-in object instance is called according to the preset function name, the product information and product price contained in the event for comparing prices are passed as parameters to the event handlers, and then the event handlers can search price information of multiple products which are the same with or similar to the product in multiple shopping sites according to a predefined event handling logic therein, and generate corresponding price comparison curves presented to the user.

In one embodiment, the plug-in identification obtaining module 104 also may be configured to obtain the support plug-in list, and determine whether the plug-in identification belongs to the support plug-in list, if yes, then call the local searching module 106.

In this embodiment, as illustrated in FIG. 6, the device for loading a plug-in further includes system event handling module 114, configured to handle the plug-in calling event by calling event handlers in operating system when the plug-in identification does not belong to the support plug-in list.

The support plug-in list may be downloaded by the server, and the support plug-in list may record the plug-in identification of the published plug-in stored in the server.

When the plug-in identification does not belong to the support plug-in list, it means that the browser and the plug-in supported by the browser cannot handle the plug-in calling event, and the plug-in calling event will be thrown on to become a operating system event, and then the operating system event is handled via calling the event handlers of the operating system.

As mentioned in the previous embodiment, in one application scene, if a webpage which the user browsed includes resource files of pdf document, but there is not a corresponding plug-in for viewing pdf document in the support plug-in list, then a plug-in calling event of preview pdf document will be thrown on, and then the pdf document may be previewed via calling an interface function of pdf view program in the operating system. For example, the pdf document may be previewed by calling the interface function of pdf application programs such as adobe reader or foxit reader, etc., and then the pdf document name is passed as a parameter to the interface function, to preview the pdf document.

In another application scene, referring to FIGS. 2, 3 and 4, the user can click on a toolbar of a mobile phone browser to expand the support plug-in list. The toolbar displays a plurality of the plug-ins in the support plug-in list as icons. If the user wants to call “EverNote” plug-in to record essays diary, then he would click on the icon corresponding to the “EverNote” plug-in to trigger a plug-in calling event. After the browser captures the plug-in calling event, it is found that the

“EverNote” plug-in has not been downloaded by searching in local, then the “EverNote” plug-in will be downloaded by accessing the browser according to the preset plug-in download address, at the same time a download progress of the runtime files corresponding to the plug-in is displayed as a progress bar below the icon. After the download, it will be stored in a preset storage address in local, and then the storage address is recorded in the local plug-in list, at the same time, the runtime files which have been downloaded is loaded, and then the plug-in object instance is created by the reflection mechanism, and corresponding event handlers in the plug-in object instance to handle the plug-in calling event, that is expanding an input window for entering notes to facilitate the user's input. The whole process does not need to install application program through the operating system, and it does not need to restart the browser after download, thereby it provide convenient for the user on calling the plug-in, improving browsing speed.

The method and device for loading a plug-in can automatically download the runtime files corresponding to the plug-in when the browser is not installed with a plug-in, and then call corresponding event handlers to handle plug-in calling event by loading the runtime files, allowing the user to call the plug-in without installing the plug-in through operating system. And there is no need to restart the browser to reload the installed plug-in during the calling procedure, which facilitates the users in calling the browser plug-in, thus improves browsing speed.

A person skilled in the art will understand that the performance of all or part of the process of the method in the embodiments can be achieved by a computer program to instruct relevant hardware. The computer program may be stored in a computer-readable storage medium, wherein the storage medium may be a magnetic disk, optical disk, read only memory (ROM), or random access memory (RAM) and so on. When the computer program is implemented, it may include the process described in the embodiments of the method.

The foregoing are only several embodiments of the present disclosure, of which the description are more specific and detailed, it is to be understood that the embodiments are not to be limited to the scope of the present disclosure. It should be noted that, for a person skilled in the art, a number of variations and modifications may be made without departing from the inventive concept or scope of the present disclosure. Accordingly, the protection scope of the present disclosure is subject to the appended claims.

1. A method for loading a plug-in, wherein the method comprises:
capturing, at a terminal, a plug-in calling event;
obtaining, at a terminal, a plug-in identification corresponding to the plug-in calling event;
searching, at a terminal, for runtime files corresponding to the plug-in identification locally;
obtaining, at a terminal, a preset plug-in download address when the runtime files are not found, and downloading, at a terminal, the runtime files corresponding to the plug-in identification according to the plug-in download address;
loading, at a terminal, the runtime files, and calling, at a terminal, corresponding event handlers to handle the plug-in calling event.

2. The method according to claim 1, wherein the method further comprises:
reading, at a terminal, the runtime files when the runtime files are found, and continuing loading the runtime files.

3. The method according to claim 1, wherein before searching, at a terminal, for runtime files corresponding to the plug-in identification in local, the method further comprises:
obtaining , at a terminal, a support plug-in list;
determining, at a terminal, whether the plug-in identification belongs to the support plug-in list, if yes, then performing the step of searching, at a terminal, for runtime files corresponding to the plug-in identification locally.

4. The method according to claim 3, wherein after determining, at a terminal, whether the plug-in identification belongs to the support plug-in list, the method further comprises:
if the plug-in identification does not belong to the support plug-in list, handling the plug-in calling event by calling , at a terminal, the event handlers in an operating system.

5. The method according to claim 1, wherein the method further comprises:
verifying, at a terminal, the runtime files.

6. The method according to claim 1, wherein the step of calling, at a terminal, corresponding event handlers to handle the plug-in calling event comprises:
creating, at a terminal, a plug-in object instance corresponding to the runtime files through a reflection mechanism;
calling, at a terminal, event handlers of the plug-in object instance to handle the plug-in calling event.

7. A terminal for loading a plug-in, wherein the terminal including a device which comprises:
an event capturing module configured to capture a plug-in calling event;
a plug-in identification obtaining module configured to obtain a plug-in identification corresponding to the plug-in calling event;
a local searching module configured to find runtime files corresponding to the plug-in identification in local;
a plug-in downloading module configured to obtain a preset plug-in download address when the runtime files are not found, and download runtime files corresponding to the plug-in identification according to the plug-in download address;
a plug-in loading module configured to load the runtime files, and call corresponding event handlers to handle the plug-in calling event.

8. The terminal according to claim 7, wherein the device further comprises a local reading module, configured to read the runtime files when the runtime files are found, and continue calling the plug-in loading module.

9. The terminal according to claim 7, wherein the plug-in identification obtaining module is further configured to obtain a support plug-in list, and call the local searching module if the plug-in identification belongs to the support plug-in list.

10. The terminal according to claim 9, wherein the device further comprises a system event handling module, configured to handle the plug-in calling event by calling the event handlers in an operating system when the plug-in identification does not belong to the support plug-in list.

11. The terminal according to claim 7, wherein the plug-in downloading module is further configured to verify the runtime files.

12. The terminal according to claim 7, wherein the plug-in loading module is further configured to create a plug-in object instance corresponding to the runtime files through a reflection mechanism, and call the event handlers of the plug-in object instance to handle the plug-in calling event.

13. A non-transitory computer-readable storage medium comprising an executable program to execute a method for loading a plug-in, wherein the method comprises:
capturing, at a terminal, a plug-in calling event;
obtaining, at a terminal, a plug-in identification corresponding to the plug-in calling event;
searching, at a terminal, for runtime files corresponding to the plug-in identification locally;
obtaining, at a terminal, a preset plug-in download address when the runtime files are not found, and downloading, at a terminal, the runtime files corresponding to the plug-in identification according to the plug-in download address;
loading, at a terminal, the runtime files, and calling, at a terminal, corresponding event handlers to handle the plug-in calling event.

14. The non-transitory computer-readable storage medium according to claim 13, wherein the method further comprises:
reading, at a terminal, the runtime files when the runtime files are found, and continuing loading the runtime files.

15. The non-transitory computer-readable storage medium according to claim 13, wherein before searching, at a terminal, for runtime files corresponding to the plug-in identification locally, the method further comprises:
obtaining , at a terminal, a support plug-in list;
determining, at a terminal, whether the plug-in identification belongs to the support plug-in list, if yes, then performing the step of searching, at a terminal, for runtime files corresponding to the plug-in identification locally.

16. The non-transitory computer-readable storage medium according to claim 13, wherein after determining, at a terminal, whether the plug-in identification belongs to the support plug-in list, the method further comprises:
if the plug-in identification does not belong to the support plug-in list, handling the plug-in calling event by calling the event handlers in an operating system.

17. The non-transitory computer-readable storage medium according to claim 13, wherein the method further comprises:
verifying, at a terminal, the runtime files.

18. The non-transitory computer-readable storage medium according to claim 13, wherein the step of calling, at a terminal, corresponding event handlers to handle the plug-in calling event comprises:
creating, at a terminal, a plug-in object instance corresponding to the runtime files through a reflection mechanism;
calling, at a terminal, event handlers of the plug-in object instance to handle the plug-in calling event.
